(19) United States
(12) Patent Application Publication
(10) Pub. No.: US 2009/0298985 A1
(43) Pub. Date: Dec. 3, 2009

(54) Themoplastic Polymer Additive Compositions

(76) Inventors: David John Kemmish, Lancashire (GB); Fuquan Zeng, Hong Kong (CN)

Correspondence Address: FAY SHARPE LLP, 1228 Euclid Avenue, 5th Floor, The Halle Building, Cleveland, OH, 44115, US

(21) Appl. No.: 11/992,996

(22) PCT Filed: Sep. 29, 2006
(86) PCT No.: PCT/GB2006/003657

§ 371 Date: Jul. 8, 2009

(30) Foreign Application Priority Data
Oct. 1, 2005 (GB) 0520004.3

(51) Int. Cl. C08K 5/13; C09K 3/00

(52) U.S. Cl. 524/335; 252/182.23; 252/182.28; 252/182.14

(57) ABSTRACT

A thermoplastic polymer additive composition for addition to a thermoplastic moulding composition to reduce discoloration and/or haze and/or increase the degree of light transmission after moulding of the composition comprises at least one hindered phenol compound and at least one acetaldehyde scavenger. The additive composition may be of particular utility when added to a polyester such as polyethylene terephthalate.

This invention relates to thermoplastic polymer additive compositions and their use. In particular it relates to such additive compositions that are useful as colour stabilisers for thermoplastic moulding compositions and thermoplastic materials, especially when such materials are recycled.

Polyethylene terephthalate is widely employed in the manufacture of packaging items. One large application for polyethylene terephthalate is in the manufacture of food packaging items and, in particular, beverage bottles. Such beverage bottles are extensively utilised for carbonated soft drinks and are increasingly more attractive, for safety considerations, in the packaging of alcoholic beverages such as beer. Bottles used for still or carbonated water or other soft drinks are typically colourless, green or blue. However, this invention is particularly, although not exclusively, concerned with colourless and near-colourless bottles.

Other uses for polyethylene terephthalate moulding compositions include the manufacture of packages for agrochemicals, cosmetics, detergents and the like.

Polyethylene terephthalate bottles are usually manufactured using a two stage process. Granules of the polyethylene terephthalate, along with any relevant additives, are injection moulded in a first step to produce a preform. The resulting preform is then blow moulded, possibly at a different factory, in a second step to the desired shape. Machines are also available which make bottle preforms and then blow them immediately into bottles.

Typical temperatures required for injection moulding of polyethylene terephthalate moulding compositions are between about 260° C. and about 285° C. or higher, e.g. up to about 310° C. Somewhat lower temperatures in excess of about 100° C. up to about 130° C. or more are generally used in the blow-moulding step to produce a bottle from a polyethylene terephthalate preform.

It is a recognised phenomenon within the industry that use of extended dwell times at elevated temperatures, particularly during the injection moulding step used to make a polyethylene terephthalate bottle preform but also possibly during the subsequent blow moulding step, may tend to result in an inferior colouration of the preform or blow moulded bottle, in particular by yellowing of colourless materials, and/or inferior light transmission (e.g. haze, clearness or clarity) properties.

A further problem is that, under the high temperatures and shear conditions needed for injection molding to make a preform and for blow molding of the preform to make a bottle, polyethylene terephthalate tends to degrade, resulting in the formation of acetaldehyde. The presence of acetaldehyde in the material of the finished bottle is undesirable, particularly when the bottle is to be used for products for human consumption, because the acetaldehyde can migrate from the walls of the package or bottle into its contents, whereupon it adversely affects the flavor and fragrance properties of the comestible product. The presence of even minute amounts of acetaldehyde in a non-carbonated drink, such as still mineral water, tends to impart a most undesirable adverse taste and odour to the drink. It is known to add acetaldehyde scavengers to polyethylene terephthalate to address the aforementioned problem; however such scavengers introduce additional problems in that they tend to adversely affect light transmission and colour properties of the polyethylene terephthalate moulded article.

It is further recognised that, with an increase in usage of polyethylene terephthalate and other thermoplastic materials for manufacture of packaging and other articles, a greater need arises to address the problem of disposal of the waste material. With land fill space becoming evermore scarce and with society being generally more environmentally aware than ever before, there is an increasing demand that the recycling option be taken. A limited amount of recycled polyethylene terephthalate material is already employed to produce strapping for packaging. Recycled polyethylene terephthalate is also used in the fibre industry to provide such products as wadding and sound insulation for cars and carpets. However, a more satisfactory option would be to recycle colourless or substantially colourless packaging of a sufficient quality such that it may be reused for food or drink applications. Presently, colourless polyethylene terephthalate material may be recycled or reused either with or without the addition of colouring. However, the recycling of colourless polyethylene terephthalate can give rise to a yellowing of the recycled material. The light transmission properties (e.g. haze, clearness or clarity) of the recycled material may also be unsatisfactory compared to the original material.

It would be desirable to be able to recycle previously used colourless or substantially colourless polyethylene terephthalate in order to produce a material whose colour would permit it to be recycled for further use, for example as a recycled, colourless or substantially colourless, polyethylene terephthalate bottle.

There is a need to provide a thermoplastic polymer additive composition for incorporation into polyethylene terephthalate moulding compositions that will stabilise the colour of the polyethylene terephthalate on injection moulding and/or on recycling. There is a further need to provide a substantially colourless polyethylene terephthalate moulding composition that, after having been formed into bottles or other moulded articles, is suitable for recycling to make further bottles or other articles of a commercially acceptable colour.

There is a further need to provide colourless or substantially colourless blow moulded articles, such as bottles, and colourless or substantially colourless preforms therefor, which exhibit good gas barrier properties and which provide protection for the contents against ultra-violet light, and which have a good recycling potential.

It is an object of the present invention to provide recycling potential to colourless articles made from polyethylene terephthalate where that has not been possible or desirable previously due to restrictions placed upon the utility of the recycled material as a result of its colour and/or light transmission properties.

According to a first aspect of the present invention there is provided a thermoplastic polymer additive composition for addition to a thermoplastic moulding composition, said additive composition comprising at least one hindered phenol compound and at least one acetaldehyde scavenger.

Preferably, the additive composition is such that when it is added to a moulding composition (and a 2.5 mm thick plaque is made as described in Example 1 hereinafter), the % transmission at 450 nm and/or 550 nm of the moulding composition which includes the additive composition (e.g. the plaque) is greater than the % transmission measured in an identical manner on an identical material (e.g. plaque) except that such material does not include a hindered phenol compound.

It is postulated that the deleterious effects on light transmission and/or on colour properties of polyethylene terephthalate moulded articles apparently caused by acetaldehyde scavengers can be mitigated by the inclusion in the melt of a hindered phenol compound. Accordingly, in a second aspect, the present invention provides the use of a hindered phenol compound as an additive in a polyethylene terephthalate moulding composition comprising an acetaldehyde scavenger to reduce discolouration and/or haze and/or increase the degree of light transmission after moulding of the composition. The moulding composition may be a recyclate, in which case the use of a hindered phenol compound is thought to be particularly effective in reducing discolouration and/or haze, which may occur as a result of solid stating procedures used during recycling.

In a third aspect, the invention extends to a method of increasing the degree of light transmission after moulding of a polyethylene terephthalate moulding composition comprising an acetaldehyde scavenger, the method comprising including a hindered phenol compound as an additive in the moulding composition.

The hindered phenol compound and the acetaldehyde scavenger may be added concurrently to a moulding composition; or the hindered phenol compound may be added to a moulding composition which already includes a said acetaldehyde scavenger. In a less preferred embodiment, an acetaldehyde scavenger may be added to a moulding composition which already includes a hindered phenol compound.

An increase in the degree of light transmission in accordance with the second and third aspects may be confirmed by comparing the % transmission (at 450 nm and/or 550 nm) after moulding a said moulding composition which includes a said hindered phenol compound as a said additive, to a moulding composition which is equivalent in all respects except that it does not include a said hindered phenol compound.

An increase in the degree of light transmission may be confirmed using the procedure set forth in Example 1 hereinafter.

Preferably, inclusion of the hindered phenol compound results in an increase in the degree of light transmission (of for example a plaque) after moulding across at least 50% (preferably at least 60%, more preferably at least 70%, especially at least 80%) of the wavelength range 400-600 nm. An increase as aforesaid will be readily apparent from a plot of % transmission against wavelength, for example as shown in figures hereinafter.

It has been found that hindered phenol compounds are capable of acting synergistically with acetaldehyde scavengers to reduce acetaldehyde content.

Accordingly, in a fourth aspect, the invention further provides the use of a hindered phenol compound as an additive in a thermoplastic moulding composition comprising polyethylene terephthalate and an acetaldehyde scavenger for, synergistically with the acetaldehyde scavenger, reducing the acetaldehyde content of a moulded article formed from the composition.

The thermoplastic polymer additive composition of the invention may be provided in a form suitable for direct addition to a thermoplastic melt or pre-melt granular composition. For example, the thermoplastic polymer additive composition may be uniformly dispersed in an inert liquid carrier therefor.

The thermoplastic moulding composition is preferably one that tolerates or requires high temperature processing conditions, for example use of an injection moulding temperature of at least about 200° C. Suitable materials include polyethylene terephthalate.

In order to mould articles from a thermoplastic moulding composition it is necessary to heat the composition to a temperature above its softening point. However, it is normally preferred to perform moulding at a temperature below the melting point of the thermoplastic polymer material present in the thermoplastic moulding composition. In the practice of the present invention, it will often be preferred to utilise thermoplastic polymer materials in the moulding composition which can tolerate, or which require the use of, high processing temperatures, for example temperatures of at least about 200° C. Some moulding processes may require the use of more severe processing conditions than others. For example, in the formation of a blow moulded polyethylene terephthalate bottle, injection temperatures in the range of from about 260° C. to about 285° C. or more, e.g. up to about 310° C., can be used in the course of forming a bottle preform whereas a lower temperature of, for example, from about 100° C. up to about 170° C. is typically used, in combination with a suitable high air pressure of, for example, about 40 bar, in order to blow a bottle of the desired shape from the bottle preform.

Mechanical recycling procedures may involve the following steps:

1. Collection (e.g. of bottles). This is usually organised through bottle collection points and some times by street collection.
2. Colour sorting. This is often done manually although more in-line automated systems are becoming available. The commercial value of polyethylene terephthalate coloured bottles is: clear>blue>green>amber/other transparent and translucent colours>opaque. Clear, blue and green can be blended to give an acceptable final resin colour. Other colours find use either in strapping and staple fibre. There are also some applications in crates and pallets. The recycling of colourless or substantially colourless bottles to produce recycled colourless or substantially colourless bottles has been difficult because of the tendency of the recycled materials to yellow and/or become hazy.
3. Grinding. Typically the bottles are ground into fragments of typical thickness 0.15 to 2 mm in size of approximately 1 to 2 cm.
4. Separation of polyethylene terephthalate from contaminants. This is usually done by flotation or other means such as air separation. This removes closures, labels, internal barrier layers, soil etc.
5. Washing. Typical composition of a wash is 1.8% sodium hydroxide. Bottles are typically washed at 80° to 85° C. This removes external barrier layers, plus more importantly, microbiological material and potentially toxic compounds.
6. Drying. Usually by hot air.
7. Extrusion and pelletizing. A vacuum pump is employed to remove volatiles.
8. Solid stating. This is usually conducted by convected heating and 200° C. for 8 to 12 hours, or longer—for example up to about 16 hours or even more. This increases the IV to the required level. For bottle blowing this is typically 0.72-0.84 dL/g.

The solid stating procedure in recycling has tended to cause a yellowing in polyethylene terephthalate materials, particularly in such materials that contain an acetaldehyde scavenger. It has now been discovered that in the recycling of a polyethylene terephthalate material that comprises an acetaldehyde scavenger, the addition to the recyclates of a hindered phenol compound before the solid stating step can reduce this problem.

Said hindered phenol compound suitably includes a phenol moiety which is independently substituted, in both positions ortho to the —OH group of the phenol moiety, with optionally-substituted alkyl moieties. Said hindered phenol compound may be substituted in at least one position ortho to the —OH group with a t-butyl moiety or if the hindered phenol compound does not include a t-butyl moiety ortho to the —OH group, the phenol moiety is preferably substituted in a position meta to the —OH group, for example by an optionally-substituted alkyl group. Where the hindered phenol compound does not include a t-butyl moiety, it may be substituted in each meta position, suitably by an optionally-substituted alkyl group.

Said hindered phenol compound may include a moiety of formula

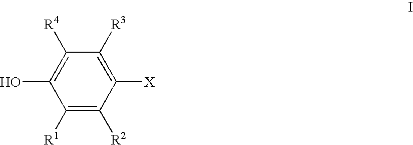

wherein
R¹ is an optionally-substituted C₁-C₄ alkyl,
R² represents a hydrogen atom or a group X,
R³ represents a hydrogen atom or together with said group X arranged para to the —OH group defines a cyclic, for example a heterocyclic ring, preferably a six-membered ring,
R⁴ represents a C₁-C₄ alkyl,
X is methylene or —(CH₂)ₙ—CO—Y—,
Y is oxygen or —NH—,
and, n represents 0, 1, 2, 3 or 4.

Preferably, R⁴ represents a t-butyl group, R¹ represents a methylene moiety, a methyl group or a t-butyl group, R² represents a hydrogen atom or a methylene moiety, R³ represents a hydrogen atom, X represents a methylene moiety or —(CH₂)ₙ—CO—Y— wherein n represents 0, 1, 2, 3 or 4 and Y is oxygen or —NH—.

Preferably, said compound I includes at least two t-butyl moieties each of which is preferably bonded to a phenol moiety.

Preferably, R¹ and R⁴ represent the same atom or group. Each preferably represents a t-butyl group.

Preferably, R² and R³ represent the same atom or group. Each preferably represents a hydrogen atom.

Moiety X may be directly bonded to an optionally-substituted C₁₋₂₅ alkyl group; an optionally-substituted

C₂₋₁₂ alkylene group which is optionally interrupted by an oxygen or sulphur atom; an optionally-substituted phenol moiety (in which case moiety X may represent a methylene moiety and the hindered phenol compound I may be symmetrical about said moiety); a moiety

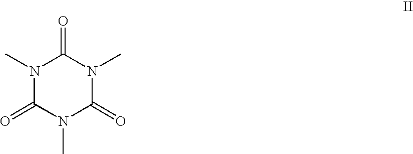

where the lines from each N-atom represent free bonds which are linked to other atoms or groups and one of which is linked to moiety X; an identical moiety I, especially wherein X represents —(CH)ₙ—CO—Y— and Y represents —NH—, so the hindered phenol compound is symmetrical about a bond linking two —NH— moieties; a moiety

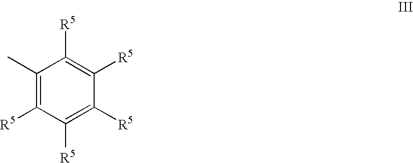

wherein the line between the two R⁵ groups represents the position at which moiety X is bonded to the phenyl moiety of moiety III and wherein each R⁵ represents an optionally-substituted alkyl group (especially an optionally-substituted methyl group); or a moiety

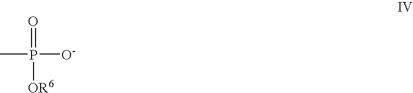

wherein the line extending from the P atom shows the position of the bond to the X moiety and wherein R⁶ represents a C₁₋₄ alkyl group.

In moiety II, each nitrogen atom may be directly bonded to a respective moiety of formula I.

In moiety III one or more, (suitably two) of R⁵ may consist of a moiety of formula I, especially the two moieties R⁵ in the meta positions to the free bond in said moiety III.

A moiety IV may be of formula

([moiety I]-[moiety IV]⁻)₂M²⁺

wherein M represents a metal, for example calcium.

Said hindered phenol compound preferably includes a moiety of formula

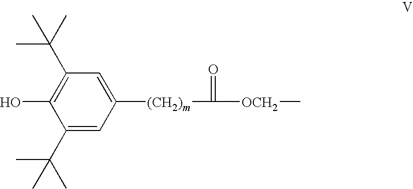

wherein m represents 0, 1, 2, 3 or 4 (preferably 0 or 2) and the line attached to the —OCH₂— group represents the position at which moiety V is bonded to another atom or group.

Said moiety V is preferably bonded to a moiety which includes a CₚHₚ+₁ moiety where p is at least 4. Said moiety V is preferably bonded to a moiety which includes at least 14, preferably at least 16 carbon atoms; and preferably include at least 50 hydrogen atoms.

Said hindered phenol compound preferably include at least one ester group.

Said hindered phenol compound may have a molecular weight of at least 300, preferably at least 400. The molecular weight may be less than 1500, preferably less than 1300, more preferably less than 800.

Said hindered phenol compound preferably does not comprise

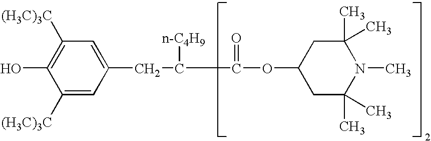

Said hindered phenol compound may be selected from 3,5-Di-tert-butyl-4-hydroxybenzoic acid, hexadecyl ester (Cyasorb UV-2908), 2,2′-Methylenebis(4-ethyl-6-tert-butylphenol) (Cyanox 425), 2,2′-Methylenebis(4-methyl-6-tert-butylphenol) (Cyanox 2246), 1,3,5-Tris(3,5-di-tert-butyl-4-hydroxybenzyl)-s-triazine-2,4,6-(1H,3H,5H)-trione (Cyanox 1741), 1,3,5-Tris(4-tert-butyl-3-hydroxy-2,6-dimethyl benzyl)-1,3,5-triazine-2,4,6-(1H,3H,5H)-trione Tris(2,4-di-tert-butylphenyl) phosphite (Cyanox 2888), tetrakis[methylene-3(3′,5′-di-t-butyl-4′-hydroxyphenyl)propionate]methane (Irganox 1010), octadecyl-3,5-di-tert-butyl-4-hydroxyhydrocinnamate (Irganox 1076), thiodiethylene bis(3,5-di-tert-butyl-4-hydroxyhydrocinnamate) (Irganox 1035), 3,5-bis(1,1-Dimethylethyl)-4-hydroxybenzenepropionic acid (Irganox MD1024), 1,3,5-Trimethyl-2,4,6-Tris (3,5-di-tert-butyl-4-hydroxy)benzene (Irganox 1330), Calcium bis[monoethyl (3,5-di-tert-butyl-4-hydroxybenzyl)phosphonate] (Irganox 1425 wl), 2,5,7,8-Tetramethyl-2(4′,8′,12′-trimethyltridecyl)curoman-6-ol (Irganox E201), Tris (3,5-di-tert-butyl-4-hydroxybenzyl)-isocyanurate (Irganox 3114).

Said hindered phenol compound is preferably selected from 2,2′-Methylenebis(4-ethyl-6-tert-butylphenol) (Cyasorb UV-2908 and tetrakis[methylene-3(3′,5′-di-t-butyl-4′-hydroxyphenyl)propionate]methane (Irganox 1010).

Said thermoplastic polymer additive composition suitably has a weight of at least 50 g, preferably at least 100 g, more preferably at least 500 g, especially at least 1 kg.

Preferred acetaldehyde scavengers include one or more nitrogen atoms. Preferably, the nitrogen atoms are not bonded to other atoms by double or triple bonds, but are preferably bonded to three other atoms by single bonds. Preferred scavengers include amine moieties. Preferred amine moieties are primary and secondary amine moieties. Especially preferred are scavengers which include a —NH₂ moiety.

In one embodiment, preferred acetaldehyde scavengers include both amine moieties as described and amide moieties. In one embodiment, preferred acetaldehyde scavengers include a substituted phenyl moiety. In one preferred embodiment, a said acetaldehyde scavenger may include an amine moiety (especially —NH₂), an amide moiety (especially —CONH₂) and a substituted phenyl moiety. In this case, it is preferred that both the amine moiety and the amide moiety are directly bonded to the phenyl moiety. Preferably, the amine moiety and amide moiety are bonded ortho to one another.

One class of acetaldehyde scavengers may be as described in U.S. Pat. No. 5,340,884 (Eastman), the content of which as regards the scavengers is incorporated herein by reference. In this case, the scavenger may be a polyamide selected from the group consisting of low molecular weight partially aromatic polyamides having a number average molecular weight of less than 15,000, low molecular weight aliphatic polyamides having a number average molecular weight of less than 7,000, and combinations thereof. Preferred low molecular weight partially aromatic polyamides include: poly(m-xylylene adipamide), poly(hexamethylene isophthalamide), poly(hexamethylene adipamide-co-isophthalamide), poly(hexamethylene adipamide-co-terephthalamide), and poly(hexamethylene isophthalamide-co-terephthalamide). The most preferred low molecular weight partially aromatic polyamide is poly(m-xylylene adipamide) having a number average molecular weight of 4,000 to 7,000 and an inherent viscosity of 0.3 to 0.6 dL/g. Preferred low molecular weight aliphatic polyamides include poly(hexamethylene adipamide) and poly(caprolactam). The most preferred low molecular weight aliphatic polyamide is poly(hexamethylene adipamide) having a number average molecular weight of 3,000 to 6,000 and an inherent viscosity of 0.4 to 0.9 dL/g.

Another class of acetaldehyde scavengers may be as described in U.S. Pat. No. 6,762,275 (Coca-Cola), the content of which as regards the scavenger is incorporated herein by reference. In this case, the scavenger may include at least two component molecular fragments, each component molecular fragment comprising at least two hydrogen substituted heteroatoms bonded to carbons of the respective component molecular fragment. The component molecular fragments of the organic additive compound are each reactive with acetaldehyde in a polyester to form water and a resulting organic molecular fragment comprising an unbridged five or six member ring including the at least two heteroatoms. Preferably, the organic additive compounds have at least twice the molecular weight of the component molecular fragments alone. The heteroatoms present in each molecular fragment capable of reacting with acetaldehyde include oxygen (O), nitrogen (N), and sulfur (S). The heteroatoms of the component molecular fragments suitably have at least one bond to an active hydrogen (H), and in the course of condensing with acetaldehyde should split off water. Preferred functional groups containing these heteroatoms include amine (NH2 and NHR), hydroxyl (OH), carboxyl (CO2H), amide (CONH2 and CONHR), sulfonamide (SO2NH2), and thiol (SH). It is necessary for these functional groups to be sterically arranged so that on condensation with AA an unbridged 5 or 6 member ring can be formed. It is preferred that the structural arrangement allows the formation of a six membered ring. It is especially preferred that heteroatoms of the organic additive are attached to a preformed ring or rings. It is most preferred that the preformed ring(s) are aromatic so that the unbridged 5 or 6-member ring of the resulting organic compound is bonded to the aromatic ring. Suitable organic additive compounds may be substantially thermally stable at the temperatures required for melt-processing the polyester. It is also preferred that the functional groups present on the organic additive are relatively unreactive towards the ester linkages present in polyesters. Examples of preferred scavengers include 1,2-bis(2-aminobenzamidoyl)ethane; 1,2-bis(2-aminobenzamidoyl)propane; 1,3-bis(2-aminobenzamidoyl)propane; 1,3-bis(2-aminobenzamidoyl)pentane; 1,5-bis(2-aminobenzamidoyl)hexane; 1,6-bis(2-aminobenzamidoyl)hexane; and 1,2-bis(2-aminobenzamidoyl)cyclohexane. More preferred are scavengers where the component molecular fragments are derived from anthranilamide, because of their low cost, efficacy, and ease of incorporation into PET.

An especially preferred scavenger of said class is 1,6-bis(2-aminobenzamidoyl hexane).

Another group of acetaldehyde scavengers suitable for use in the present invention include Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil, α-tocopherol, triglycerin, trimethylolpropane, dipentaerythritol, tripentaerythritol, D-mannitol, D-sorbitol, and xylitol. From the aforementioned group, Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil are preferred.

Preferably, the thermoplastic moulding composition comprises a polyester, especially polyethylene terephthalate. Polyethylene terephthalate used for injection moulding purposes is typically post-condensed and has a molecular weight in the region of about 25,000 to 30,000. However, it has also been proposed to use a fibre grade polyethylene terephthalate that is cheaper but is non-post-condensed, with a lower molecular weight in the region of about 20,000. It has further been suggested to use co-polyethylene terephthalates of polyethylene terephthalate which contain repeat units from at least 85 mole % terephthalic acid and at least 85 mole % of ethylene glycol. Dicarboxylic acids which can be included, along with terephthalic acid, are exemplified by phthalic acid, isophthalic acid, naphthalene-2,6-dicarboxylic acid, cyclohexanedicarboxylic acid, cyclohexanediacetic acid, diphenyl-4,4′-dicarboxylic acid, succinic acid, glutaric acid, adipic acid, azelaic acid and sebacic acid. Other diols which may be incorporated in the co-polyethylene terephthalates, in addition to ethylene glycol, include diethylene glycol, triethylene glycol, 1,4-cyclohexanedimethanol, propane-1,3-diol, butane-1,4-diol, pentane-1,5-diol, hexane-1,6-diol, 3-methylpentane-2,4-diol, 2-methyl pentane-1,4-diol, 2,2,4-trimethylpentane-1,3-diol, 2-ethylhexane-1,3-diol, 2,2-diethylpropane-1,3-diol, hexane-1,3-diol, 1,4-di(hydroxyethoxy)-benzene, 2,2-bis-(4-hydroxycyclohexyl)-propane, 2,4-dihydroxy-1,1,3,3-tetramethyl-cyclobutane, 2,2-bis-(3-hydroxyethoxyphenyl)-propane, and 2,2-bis-(4-hydroxypropoxyphenyl)-propane. In this specification the term “polyethylene terephthalate” includes not only polyethylene terephthalate but also such co-polyethylene terephthalates.

Injection moulding of polyethylene terephthalate and other polyethylene terephthalate moulding compositions is typically carried out using an injection moulding machine and a maximum barrel temperature in the range of from about 260° C. to about 285° C. or more, for example, up to about 310° C. The dwell time at this maximum temperature is typically in the range of from about 15 seconds to about 5 minutes or more, preferably from about 30 seconds to about 2 minutes.

It is well known within the industry that polyethylene terephthalate does not exhibit good gas barrier properties. When producing bottles that will be used to package carbonated drinks or alcoholic beverages it is desirable to prevent carbon dioxide from escaping and being replaced by oxygen. It has accordingly been proposed to add a polyamide to the thermoplastic polyethylene terephthalate moulding composition in order to confer improved gas barrier properties on it. Alternatively a sandwich construction may be used in which nylon or an ethylene/vinyl alcohol resin is incorporated in a multi-layer preform which is then blow moulded to form a bottle having improved gas barrier properties.

The thermoplastic polymer additive of the invention may be added as a solid masterbatch in the form of granules or powder. Alternatively, the additive may be suspended or dissolved in a liquid carrier in order to ensure a uniform dispersion of the additive throughout the polyethylene terephthalate. The liquid carrier is generally an inert material, such as a hydrocarbon oil, an ester, an alcohol, or a mixture of two or more thereof. The liquid carrier is selected to be non-toxic, to have good compatibility with polyethylene terephthalate and to possess good solvent properties (if the additive is to be dissolved in the liquid carrier). Ideally, the quantity of carrier included in the composition is kept to a minimum in order that the properties of the polyethylene terephthalate are not adversely affected. The thermoplastic polymer additive composition of the present invention may include a thermoplastic polymer-compatible organic liquid carrier. Such a carrier must be compatible with the thermoplastic polymer material of the thermoplastic moulding composition and is preferably also compatible with the other components to be included in the thermoplastic moulding composition of the invention. Typical carriers include hydrocarbons, hydrocarbon mixtures, alcohols, esters and mixtures of two or more thereof. Preferably the thermoplastic polymer-compatible organic liquid carrier is an oil based vehicle. Examples of such vehicles of the materials available as Clearslip™ 2 and Clearslip™ 3 from ColorMatrix Europe Ltd., of Unit 9-11, Unity Grove, Knowsley Business Park, Knowsley, Merseyside, L34 9GT.

The thermoplastic polymer additive composition may also include one or more further functional additives. The sum of the amounts of said further additives preferably comprises less than 5 wt %, preferably less than 2 wt %, more preferably less than 1 wt % of said additive composition.

The ratio of the weight of said acetaldehyde scavenger to the weight of hindered phenol compound used in compositions referred to herein (e.g. used in the additive composition of the first aspect or in a dispersion, masterbatch or moulding composition) is suitably at least 1, preferably is at least 2, more preferably is at least 3 and, especially is at least 4. The ratio may be less than 30, preferably less than 20, more preferably less than 10. Suitably, the ratio is in the range 2 to 10, preferably 3 to 8, more preferably 4 to 7.

In a moulding composition, for example comprising PET described herein, the amount of acetaldehyde scavenger in the composition may be in the range 0.01 to 2.0 wt %, preferably in the range 0.01 to 0.2 wt %, more preferably in the range 0.01 to 0.05 wt %. The amount of hindered phenol compound may be in the range 0.002 to 0.040 wt %, preferably in the range 0.002 to 0.01 wt %.

A mixture comprising acetaldehyde scavenger and hindered phenol compound may be provided in a concentrated form, for example in the form of a masterbatch comprising solid material for mixing with a moulding composition or in the form of a solution or suspension. In such concentrated forms, the sum of the wt % of acetaldehyde scavengers and hindered phenol compounds may be less than 50 wt %, preferably less than 40 wt % of the concentrated form; but preferably makes up at least 5 wt % of the concentrated form. When a liquid dispersion is provided, the sum of the wt % of acetaldehyde scavengers and hindered phenol compounds in the dispersion may be in the range 20 to 50 wt %, preferably 35 to 45 wt %. In a solid masterbatch, the sum of the wt % of acetaldehyde scavengers and hindered phenol compounds may be in the range 8 to 30 wt %.

When compositions include more than one type of acetaldehyde scavenger and/or more than one type of hindered phenol compound, ratios and/or wt % referred to herein suitably refer to the sum of the amounts of scavengers and stabilisers as appropriate. Preferably, however, compositions include only a single type of acetaldehyde scavenger; and preferably include only a single type of hindered phenol compound.

In one embodiment, the amount of hindered phenol compound used in the thermoplastic moulding composition of the invention is preferably less than 1000 ppm, more preferably less than 500 ppm, even more preferably less than about 250 ppm, most preferably from about 10 to about 150 ppm. For example, the hindered phenol compound may be added in an amount of from 10 to 100 ppm of the thermoplastic moulding composition.

In one embodiment, the additive composition may be made by mixing the dry additive or additives in the form of a powder with a liquid organic carrier, typically in a range of from about 1 to about 85 wt %, more usually in the range of from about 30 to about 50 wt %. The resulting additive composition comprising the hindered phenol compound and the acetaldehyde scavenger uniformly dissolved or dispersed in the liquid carrier can then be added to the thermoplastic polymer in ranges from about 0.0001% by weight to about 7% by weight, for example, from 0.01% by weight up to about 5% by weight, based upon the weight of thermoplastic polymer component used.

It may not be desirable to use higher concentrations of the additive as this may interfere with the properties of the thermoplastic polymer material.

In another aspect of the present invention there is provided a method of making a moulded article from a colourless or substantially colourless thermoplastic moulding composition which comprises:

(a) providing a colourless or substantially colourless thermoplastic moulding composition comprising polyethylene terephthalate;
(b) admixing with the thermoplastic moulding composition at least one hindered phenol compound and at least one acetaldehyde scavenger;
(c) heating the colourless or substantially colourless thermoplastic moulding composition; and
(d) moulding the hot colourless or substantially colourless thermoplastic moulding composition so as to form a moulded article.

Typically the colourless or substantially colourless thermoplastic moulding composition is injection moulded to form a bottle preform and the resulting bottle preform is then blow moulded to form a bottle.

The invention further provides a method of a making a blow moulded bottle from a polyethylene terephthalate moulding composition which comprises:

(i) providing a colourless or substantially colourless polyethylene terephthalate moulding composition;
(ii) admixing with the polyethylene terephthalate moulding composition at least one hindered phenol compound and at least one acetaldehyde scavenger;
(iii) heating the colourless or substantially colourless polyethylene terephthalate moulding composition;
(iv) extruding the hot colourless or substantially colourless polyethylene terephthalate moulding composition so as to form a bottle preform; and
(v) blow moulding the bottle preform at a blow moulding temperature so as to form a colourless or substantially colourless bottle.

Also provided in accordance with another aspect of the present invention is a method of making a useful article which comprises:

(A) providing a colourless or substantially colourless thermoplastic moulding composition comprising polyethylene terephthalate;
(B) admixing with the thermoplastic moulding composition at least one hindered phenol compound and at least one acetaldehyde scavenger;
(C) forming a colourless or substantially colourless moulded article by a procedure including heating the colourless or substantially colourless thermoplastic moulding composition;
(D) after use of the moulded article, subjecting the material of the moulded article to recycling steps which include subjecting the material of the moulded article to elevated temperature conditions for a prolonged period of time; and
(E) re-forming the thus treated material into a useful article.

Also provided in accordance with another aspect of the present invention is a method of making a useful article which comprises:

(A) providing a colourless or substantially colourless thermoplastic moulding composition comprising polyethylene terephthalate and an acetaldehyde scavenger as an additive;
(B) forming a colourless or substantially colourless moulded article by a procedure including heating the colourless or substantially colourless thermoplastic moulding composition;
(C) after use of the moulded article, admixing with the material of the moulded article at least one hindered phenol compound;
(D) subjecting the resulting material of the moulded article to recycling steps which include subjecting the material of the moulded article to elevated temperature conditions for a prolonged period of time; and
(E) re-forming the thus treated material into a useful article.

In the re-forming step (E) typical techniques that can be used include moulding, extrusion, and other conventional processes for making articles of plastics materials, including bottles and fibres.

In such a method the colourless or substantially colourless thermoplastic (i.e. polyethylene terephthalate) moulding composition in step (B) can be injection moulded to form a bottle preform and then the resulting bottle preform can be blow moulded to form a bottle.

The invention further provides a method of making an article from a colourless or substantially colourless thermoplastic moulding composition which comprises:

(I) providing a colourless or substantially colourless thermoplastic moulding composition comprising recycled colourless or substantially colourless thermoplastic material, said recycled colourless or substantially colourless thermoplastic material containing at least one acetaldehyde scavenger;
(II) admixing with the thermoplastic moulding composition an additive comprising a hindered phenol compound; and
(III) extruding the resultant composition to form said article.

The article of step (III) may be a moulded article, such as a bottle preform, or a fibre or any other useful article, such as a tube, a crate, or the like.

Whilst a number of the aspects of the present invention utilise a moulding composition/polyethylene terephthalate which is preferably colourless or substantially colourless, a coloured moulding composition may also be used. Preferably, should a coloured moulding composition be used, it will be of a blue colour.

Polyethylene terephthalate is hygroscopic and after a period of approximately one year it is noticeable that preforms made of polyethylene terephthalate have taken up moisture from the air. Therefore, prior to the injection moulding process, polyethylene terephthalate granules for use in the invention are preferably dried for at least about 4 hours at from about 160° C. to about 190° C., in a procedure that gives a slightly tactile product. The polyethylene terephthalate granules are transferred directly from the drier to the hopper of the injection-moulding machine. The hindered phenol compound can then be added to and mixed with the thermoplastic polymer granules upon charging to the hopper. The injection moulding process typically occurs at between about 260° C. and about 285° C., more preferably at about 280° C., and the thermoplastic polymer material has a dwell time within the machine of less than 1 minute. Once the preform has been blow moulded into an appropriate article, said article may be recycled by a suitable procedure which includes use of temperatures of up to about 300° C. or greater and dwell times up to or in excess of 5 minutes.

Preferably, any use, composition or method referred to is applied to produce a plurality, suitably at least 5, preferably at least 10, more preferably at least 50, articles, for example bottles.

The invention extends to a package comprising a plurality, suitably at least 5, preferably at least 10, more preferably at least 20, articles for example bottles, and packaging material suitably arranged to secure the articles in substantially fixed positions relative to each other.

The invention is further illustrated in the following examples with reference to the accompanying figures in which:

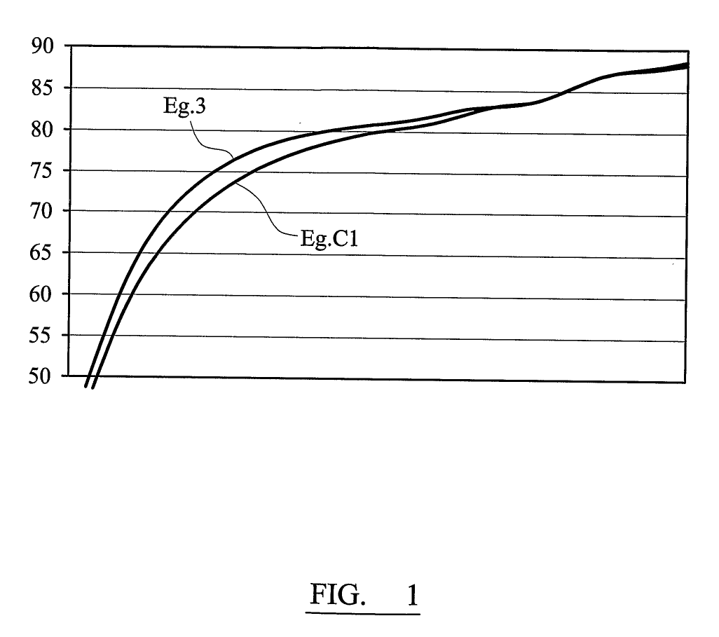

FIG. 1 is a plot of % transmission vs wavelength (in nm) for the compositions of Examples 1 and C1.

The following materials are referred to hereinafter:

Anthranilamide—an acetaldehyde scavenging agent;
VORIDIAN 9921 w—a copolymer PET obtained from Eastman Chemical Company;
CLEARTUF P82—a polyethylene terephthalate obtained from M&G Group.
Voridian AA reducer—an acetaldehyde reducing formulation from Viridian (referred to as Voridian LAAC) containing low molecular weight polyamide;
MXD6—a polyamide obtained from Mitsubishi Chemical Company;

### EXAMPLE 1

Anthranilamide acetaldehyde scavenging agent (330 ppm) and Cyasorb UV-2908 (60 ppm) were incorporated into VORIDIAN 9921w polyethylene terephthalate (PET) resin which was moulded into a 35 g weight bottle blowing preform using a HUSKY injecting moulding machine. The preform was then transferred to a bottle-blowing machine, reheated by an infrared lamp and stretch blown into a 1 litre bottle.

The blown bottle was then ground to fragments and washed with hot water, to simulate the recycle process. After washing the fragments of simulated recycled PET were dried by heating them at approximately 160° C. for five (5) hours and were then extruded at 270° C. using a laboratory extrusion rig and cut into granules.

The experimental recycled PET granules were then crystallised by holding at 160° C. for six (6) hours and then transferred to a batchwise rotation vacuum solid state polymerisation machine. During the Solid State Polymerisation (SSP) process the recycled PET granulate was first subjected to a temperature of 220° C. for sixteen (16) hours and then allowed to cool to below a temperature of 170° C.

The simulated recycled PET granulate was then injection moulded into 2.5 mm thick plaque using a BOY 22M injecting moulding machine in order to prepare samples for optical analysis.

The % light transmission at the wavelengths 450 nm and 550 nm was determined using a MINOLTA Spectrophotometer CM-3700d and results are provided in Table 1.

### EXAMPLE C1

The procedure of Example 1 was generally followed except that the Cyasorb UV-2908 was omitted. The % light transmission at the wavelengths 450 nm and 550 nm was determined in the manner described in Example 1 for a plaque prior to the simulated recycle process of Example 1 and also after the simulated recycle process. Results are summarised in Table 1.

TABLE 1

| | | |
|---|---|---|
| Composition | | |
| Examined | Time of | % TRANSMISSION |

| (Example No) | Examination | @ 450 nm | @550 nm |
|---|---|---|---|
| 1 | After simulated | 67 | 80 |
| | recycle process | | |
| C1 | Prior to simulated | 79 | 83 |
| | recycle process | | |
| C1 | After simulated | 71 | 81 |
| | recycle process | | |

The increased use of the acetaldehyde reducing agent anthranilamide in PET used to blow bottles has been found to cause a reduction in the light transmission and an increase in the yellow tint of PET when the bottles are recycled. The addition of Cyasorb UV-2908 (hindered phenol) in addition to the anthranilamide significantly reduces the loss of transparency.

### EXAMPLES 3

Colour spectrum data was determined for the compositions detailed in Examples 1 and C1, after the simulated recycle process using a Minolta Spectrophometer CM-3700D. Colour spectrum data and % transmission at 450 nm and 550 nm are provided in Table 2 and the % light transmission over the wavelengths 400 to 700 nm is represented graphically in FIG. 1.

TABLE 2

| Example | Colour Spectrum data | | | | | % Transmission | |
|---|---|---|---|---|---|---|---|
| No | L* | a* | b* | C* | h° | 450 nm | 550 nm |
| 1 | 91.91282 | −1.46708 | 9.07816 | 9.19592 | 99.17996 | 70.53 | 80.956 |
| C1 | 91.37288 | −1.19754 | 10.77664 | 10.84302 | 96.34078 | 67.288 | 79.822 |

Referring to FIG. 1, it will be noted that for all wavelengths between 400 to about 600 nm, the material of Example 1 transmits more light than for comparative Example C1 which does not include any hindered phenol. As a result, bottles (or the like) made from the material of Example 1 will appear clear and/or less coloured than bottles made out of the material of Example C1.

### Discussion

The results show that the addition of an hindered phenol to a PET and acetaldehyde scavenger composition leads to a surprising improvement in the light transmission of the material after a simulated recycle process. In addition, a reduction in acetaldehyde content may also be apparent.

The ability to improve transmission allows more flexibility in toning options, especially the use of blue toning.

1. A thermoplastic polymer additive composition for addition to a thermoplastic moulding composition, said additive composition comprising at least one hindered phenol compound and at least one acetaldehyde scavenger.

2. A composition according to claim 1, wherein said hindered phenol compound includes a moiety of formula 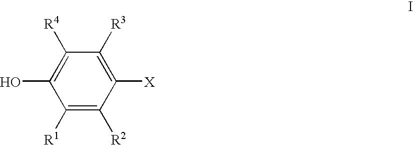
wherein
R¹ is an optionally-substituted C₁-C₄ alkyl;
R² represents a hydrogen atom or a group X;
R³ represents a hydrogen atom or together with said group X arranged para to the —OH group defines a cyclic moiety;
R⁴ represents a C₁-C₄ alkyl;
X is methylene or —(CH₂)ₙ—CO—Y—;
Y is oxygen or —NH—;
and n represents 0, 1, 2, 3 or 4.

3. A composition according to claim 1, wherein
said hindered phenol compound includes a moiety of formula 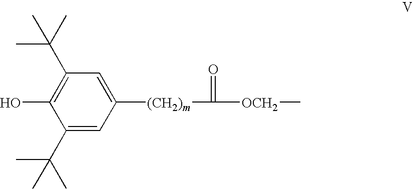
wherein m represents 0, 1, 2, 3 or 4 and the line attached to the —OCH₂— group represents the position at which moiety V is bonded to another atom or group.

4. A composition according to claim 1, wherein said hindered phenol compound is selected from 3,5-Di-tert-butyl-4-hydroxybenzoic acid hexadecyl ester, 2,2′-Methylenebis(4-ethyl-6-tert-butylphenol), 2,2′-Methylenebis(4-methyl-6-tert-butylphenol), 1,3,5-Tris(3,5-di-tert-butyl-4-hydroxybenzyl)-s-triazine-2,4,6-(1H,3H,5H)-trione, 1,3,5-Tris(4-tert-butyl-3-hydroxy-2,6-dimethyl benzyl)-1,3,5-triazine-2,4,6-(1H,3H,5H)-trione Tris(2,4-di-tert-butylphenyl) phosphate, tetrakis[methylene-3(3′,5′-di-t-butyl-4′-hydroxyphenyl)propionate]methane, octadecyl-3,5-di-tert-butyl-4-hydroxyhydrocinnamate, thiodiethylene bis(3,5-di-tert-butyl-4-hydroxyhydrocinnamate), 3,5-bis(1,1-Dimethylethyl)-4-hydroxybenzenepropionic acid, 1,3,5-Trimethyl-2,4,6-Tris (3,5-di-tert-butyl-4-hydroxy)benzene, Calcium bis[monoethyl (3,5-di-tert-butyl-4-hydroxybenzyl)phosphonate], 2,5,7,8-Tetramethyl-2(4′,8′,12′-trimethyltridecyl)curoman-6-ol, Tris (3,5-di-tert-butyl-4-hydroxybenzyl)-isocyanurate.

5. A composition according to claim 1, wherein said hindered phenol compound is selected from 2,2′-Methylenebis(4-ethyl-6-tert-butylphenol) and tetrakis[methylene-3(3′,5′-di-t-butyl-4′-hydroxyphenyl)propionate]methane.

6. A composition according to claim 1, wherein said acetaldehyde scavenger includes one or more —NH₂ moieties.

7. A composition according to claim 1, wherein said acetaldehyde scavenger includes both amine moieties and amide moieties.

8. A composition according to claim 1, wherein said acetaldehyde scavenger is selected from poly(m-xylylene adipamide), poly(hexamethylene isophthalamide), poly(hexamethylene adipamide-co-isophthalamide), poly(hexamethylene adipamide-co-terephthalamide), poly(hexamethylene isophthalamide-co-terephthalamide), 1,2-bis(2-aminobenzamidoyl)ethane; 1,2-bis(2-aminobenzamidoyl)propane; 1,3-bis(2-aminobenzamidoyl)propane; 1,3-bis(2-aminobenzamidoyl)pentane; 1,5-bis(2-aminobenzamidoyl)hexane; 1,6-bis(2-aminobenzamidoyl)hexane; 1,2-bis(2-aminobenzamidoyl)cyclohexane; anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil, 6-Amino-1-methyluracil, α-tocopherol, triglycerin, trimethylolpropane, dipentaerythritol, tripentaerythritol, D-mannitol, D-sorbitol, and xylitol.

9. A composition according to claim 1, wherein said acetaldehyde scavenger is selected from Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil and 6-Amino-1-methyluracil.

10. A composition according to claim 1, wherein the ratio of the weight of acetaldehyde scavenger to the weight of hindered phenol compound is at least 1.

11. A composition according to claim 1, wherein said hindered phenol compound is selected from 2,2′-Methylenebis(4-ethyl-6-tert-butylphenol) and tetrakis[methylene-3(3′,5′-di-t-butyl-4′-hydroxyphenyl)propionate]methane, and said acetaldehyde scavenger is selected from Anthranilamide, 1,8-diaminonaphalene, Allantoin, 3,4-diaminobenzoic acid, Malonamide, Salicylanilide, 6-amino-1,3-dimethyluracil (DMU), 6-Aminoisocytosine, 6-Aminouracil and 6-Amino-1-methyluracil.

12. A thermoplastic moulding composition comprising a thermoplastic, at least one hindered phenol compound and at least one acetaldehyde scavenger.

13. A composition according to claim 12, wherein the amount of acetaldehyde scavenger in the composition is in the range 0.01 to 2 wt %; and the amount of hindered phenol compound is in the range 0.002 to 0.040 wt %.

14. The use of a hindered phenol compound as an additive in a polyethylene terephthalate moulding composition comprising an acetaldehyde scavenger to reduce discolouration and/or haze and/or increase the degree of light transmission after moulding of the composition.

15. A method of increasing the degree of light transmission after moulding of a polyethylene terephthalate moulding composition comprising an acetaldehyde scavenger, the method comprising including an effect amount of a hindered phenol compound as an additive in the moulding composition.

16. A composition as claimed in claim 1, wherein the additive composition is such that when it is added to a moulding composition and a 2.5 mm thick plaque is made, the % transmission at 450 nm and/or 550 nm of the moulding composition which includes the additive composition is greater than the % transmission measured in an identical manner on an identical material except that such material does not include a hindered phenol compound.
